(19) United States
(12) Patent Application Publication
(10) Pub. No.: US 2006/0158311 A1
(43) Pub. Date: Jul. 20, 2006

(54) System for minimizing coupling nulls within an electromagnetic field

(75) Inventors: David Malcolm Hall, LOCKLEYS (AU); Franck D'Annunzio, La Ciotat (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: TAGSYS SA, LA PENNE-SUR HUVEAUNE (FR)

(21) Appl. No.: 10/546,019

(22) PCT Filed: Feb. 13, 2004
(86) PCT No.: PCT/AU04/00175

§ 371 Date: Jan. 12, 2006

(30) Foreign Application Priority Data
Feb. 18, 2003 (AU) 2003900700
Jul. 10, 2003 (AU) 2003903581

(51) Int. Cl. H04Q 5/22; G08B 13/14

(52) U.S. Cl. 340/10.2; 340/572.7

(57) ABSTRACT

A system is disclosed for avoiding and/or minimizing coupling nulls between an electromagnetic field derived from one or more sources and a plurality of randomly oriented RFID tags. The plurality of tags is arranged to move relative to the filed such that no tag is persistently located in a coupling null relative to the field. The or each tag may be translated and/or rotated relative to the electromagnetic field. Alternatively, the electromagnetic field may be translated and/or rotated relative to the tags. In a further aspect coupling nulls may be avoided by orienting a main axis of the or each source of electromagnetic radiation obliquely relative to a direction of movement of the plurality of tags.

### FIELD OF THE INVENTION

The present invention relates to a system for avoiding or at least minimizing coupling nulls between an electromagnetic field derived from one or more sources and a plurality of radio frequency identification (RFID) tags. The system may include an object management arrangement wherein information bearing electronically coded RFID tags are attached to objects which are to be identified, sorted, controlled and/or audited. In particular the system may avoid or at least minimize coupling nulls between an interrogator which creates an electromagnetic interrogation field and the electronically coded RFID tags.

### BACKGROUND OF THE INVENTION

The present invention is related to apparatus disclosed in applicants PCT application AU92/00143 entitled “Article Sorting System”, the disclosures of which include excitation in a shielded structure and use of a waveguide beyond cut-off for RFID, are incorporated herein by cross reference.

The object management system of the present invention may include information passing between the interrogator and the electronically coded tags, which respond by issuing a reply signal that is detected by the interrogator, decoded and consequently supplied to other apparatus in the sorting, controlling or auditing process. The objects to which the tags are attached may be animate or inanimate. In some variants of the system the frequency of the interrogating or powering field may range from LF to UHF or Microwave.

An electromagnetic source is required to create a field which may energise a tag's circuitry and/or illuminate an antenna associated with a tag for backscatter, depending on whether the tag is passive or active, eg. battery assisted.

To couple to all tags in a randomly oriented collection, when either a collection of tags or the field creation structure moves, a flux line must exist which couples to a tag in any orientation. This may be achieved simply by ensuring that multiple, eg. three, electromagnetic sources are used, each with its axis oriented in a different direction, with a most efficient case being three orthogonal directions of a Cartesian coordinate system. When two sources or multiple sources are used having only two unique source axes, a randomly oriented tag may not couple to a flux line when moved through the field or when the source structure is simply translated along one direction, and hence may not be read. However, if either the tag or antenna structure is itself rotated, during, traversal of the tag or translation of the antenna structure, the tag may couple to a flux line. Assuming that traversal and/or rotation allows a coupling flux line to dwell at a required direction for long enough, the tag should complete its reply and be read.

### SUMMARY OF THE INVENTION

The present invention may include use of a single loop antenna or portal of any shape such that persistent null coupling zones may be eliminated or minimized as the antenna or tag bearing objects are rotated while they pass through or past the antenna structure or the antenna structure is translated across the objects. Use of a set of crossed loops or portals, or multiple electromagnetic sources may be avoided in this manner.

According to one aspect of the present invention there is provided a system for at least minimizing coupling nulls between an electromagnetic field derived from one or more sources and a plurality of randomly oriented RFID tags, wherein said plurality of tags is arranged to move relative to said field such that no tag is persistently located in a coupling null relative to said field. The or each tag may be translated and/or rotated relative to the field or the field may be translated and/or rotated relative to the tags.

According to a further aspect of the present invention there is provided a system for at least minimizing coupling nulls with an electromagnetic field derived from one or more sources wherein the or each source includes a main axis that is oriented obliquely relative to a direction of movement of a plurality of randomly oriented RFID tags.

According to a still further aspect of the present invention there is provided a method for at least minimizing coupling nulls between an electromagnetic field derived from one or more sources and a plurality of randomly oriented RFID tags, said method including moving the or each RFID tag relative to said field such that the or each RFID tag is not persistently located in a coupling null relative to said field.

According to a still further aspect of the present invention there is provided a method for at least minimizing coupling nulls between an electromagnetic field derived from one or more sources and a plurality of randomly oriented RFID tags including orienting a main axis of the or each source obliquely relative to a direction of movement of said plurality of RFID tags.

The or each source of the electromagnetic field may include one or more antennas or loops and/or portals and the plurality of tags may move relative to a region associated with each source. The or each antenna, loop or portal may be of any shape or form and may include an aperture through which the plurality of tags may pass. In one form tag bearing objects may be dropped through the aperture of the antenna followed by rotation of each object through between 90 to 360 degrees relative to an initial orientation of the object, such as 180 degrees. The main axis of the or each antenna, loop or portal may be oriented at an acute angle relative to a direction of movement of the tags. In one form the main axis of the or each antenna may be oriented at 45 degrees relative to a direction of movement of tag bearing objects. Preferably, the or each antenna, loop or portal is rotated relative to the plurality of tags or the tags may be rotated relative to the or each antenna, loop or portal as the tags are being translated relative to the or each antenna, loop or portal such that no tag is persistently located in a coupling null with respect to the field.

When randomly oriented tags are present, a loop antenna having an axis that is oblique relative to a direction of movement of tag bearing objects may cause magnetic field lines to be cut by each tag if the randomly oriented tag bearing objects or the antenna are/is rotated as the objects move through or past the aperture of the loop antenna.

A system as described herein may reduce far-field radiation from an electro-magnetic source for compliance with local Electro-Magnetic Compatibility (EMC) regulations by shielding the source. The size of the shield may be reduced with the aid of magnetic material.

### BRIEF DESCRIPTION OF DRAWINGS

A preferred embodiment of the present invention will now be described with reference to the accompanying drawings wherein:

FIG. 1 shows an elliptical loop which forms a circular aperture vent arranged at an oblique angle relative to a direction of travel of an object; and

FIG. 2 shows a polygon approximation of an elliptical loop suitable for a single oblique placement.

### DESCRIPTION OF A PREFERRED EMBODIMENT

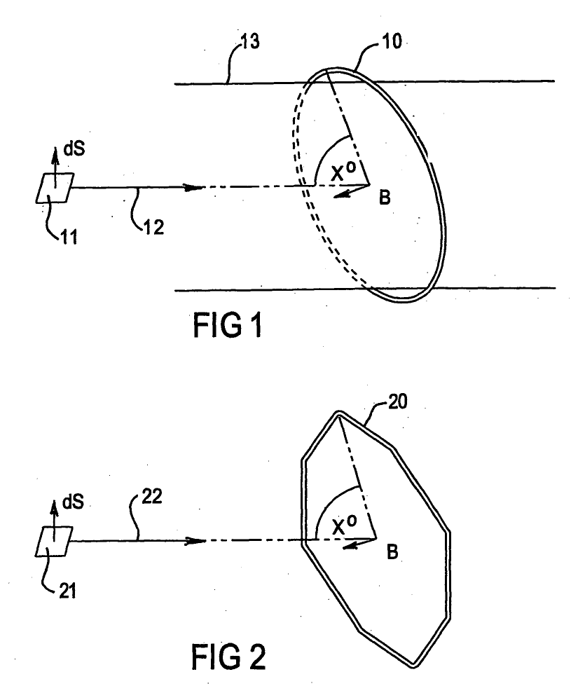

Examples of antenna loops 10, 20 are shown in FIGS. 1-2. In FIG. 1 the direction of movement through antenna loop 10 of an article 11 bearing an RFID tag is along axis 12 associated with forming cylinder 13. In FIGS. 1-2 the angle x formed between the direction of movement 12, 22 and the plane of loop 10, 20 may fall within the range 0<x<90 degrees. Using cylindrical symmetry, if the axis of loop 10,20 is oriented in a direction (ρâρ, φâφ, zâz) where ρ≠0 (oblique) and z≠0 (aperture exists) then as magnetic flux density B at loop centre point is in the same direction, coupling to a randomly oriented tag rotating about its axis of movement (âz) may be represented as a non-zero flux Ψ at some φ_{tag}, wherein Ψ is the angle between the magnetic field B and the tag's axis which is taken to point in a direction dS. Then Ψ∝B·dS
=Bρ(Sₓ cos φ_{tag}+S_{y} sin φ_{tag})+B_{φ}(−Sₓ sin φ_{tag}+S_{y} cos φ_{tag})+B_{z}S_{z}
=B_{ρ}(Sₓ cos φ_{tag}+S_{y} sin φ_{tag})+B_{z}S_{z} as B_{φ} may be zero but B_{ρ}≠0 and B_{z}≠0
≠0 for some φ_{tag}, as Sₓ S_{y}, and S_{z} cannot all be simultaneously 0

Hence a single loop antenna 10, 20 having its axis oriented with an oblique angle x relative to a direction of movement 12, 22 of a tag bearing object 11, 21, or translation of the antenna in conjunction with rotation of either the tag bearing object or the antenna should eliminate the effect of null coupling.

Loop antenna 10, 20 preferably includes a construction which uses a self-balun method that entails cable entry at opposite ends of a break in a single turn loop in which tuning elements (not shown) may be located. Placing cable entry opposite the tuning elements may serve to electrically balance the loop with respect to ground for a loop which otherwise would be physically balanced with respect to ground. This approach may reduce far field radiation resulting from stray electric fields.

In the case of a magnetically coupled system in which tagged objects are passed through or in the vicinity by an aperture of a loop antenna or the antenna structure is translated across the objects, an electrical shield in the form of a tube may be placed around the loop antenna. The axes of the shield may be parallel to the direction of movement of the objects.

To electrically shield a circular loop with a conducting cylinder of diameter DI with minimal detuning, the area in the plane of the loop between the loop and the shield can be thought of as requiring the same reluctance [symbol] presented to the flux as the cross-sectional area of the loop. It turns out that in this case where D2=√2 D1 (and shield length>D1+loop height), the ratio of inductance with shield to inductance without shield is 0.84 (for a loop height to diameter ratio<0.1). For a ratio of inductance with shield to inductance without shield of 0.95 the diameter of the shield is required to be twice that of the loop (D2=2D1). This latter amount of detuning is practically acceptable. The method described can also be used for a loop and shield cross-section of a regular polygon by considering the diameter of a circle circumscribed by the loop. Other more general shapes require calculation of flux paths.

The reason that a shield reduces inductance arises from a condition of shielding wherein the magnetic field outside the shield is zero (or very small). This being the case a tangential magnetic field inside the shield material must likewise be zero. In order to maintain boundary conditions between the tangential magnetic field at the surface inside of the shield and the tangential magnetic field inside the shield material, a surface current on the inside edge of the shield must flow in order to produce a magnetic field inside the shield material which cancels the field that would have been in that region had the shield not existed. This current, however flows in anti-phase with that of the loop, so a subtracting field is present at the centre of the loop. As the definition of inductance is L=NΨ/I, then a reduction in Ψ causes a reduction in L (for constant I).

Likewise, L=N²/ [symbol] , where N is the number of turns of the loop, so a reduced flux path (as the shield closes in on the loop) has an increased reluctance [symbol] which is also consistent with reduced L.

Looking at why shielding is required in the first place, if a large loop is required for clearance of an object passing through the loop, two problem factors enter into the RFID system. One factor is that in order to maintain acceptable field at the centre of the loop sufficient current must be provided from the interrogator. As a loop's perimeter becomes larger, the radiation properties diverge from that of an electrically small loop due to non-uniform current distribution around the loop, resulting in increased radiation. The loop can be constructed by segmenting the periphery into segments joined by series capacitors of low enough reactance to not affect the matching of the loop or with a judicious choice of reactance to facilitate the matching. An alternative segmentation in the form of “pie slice” sections whose effect from the radial currents cancel is not practical for an object passing through and a further implementation where the feed is external to the loop and (possibly the shield) is unwieldy in complexity. Once the loop behaves as an electrically small loop, shielding becomes one solution to further reduce radiation to acceptable EMC limits.

A second factor is that a larger loop picks up more external noise through reciprocal reasoning of why it radiates more.

With a shield causing a reduction in inductance, a direct reduction in flux (and hence H) for the same current occurs, therefore increased current is required from the interrogator leading to increased power output and internal interrogator noise.

Other multiple antenna configurations are possible to create a field and such structures may require shielding from external noise or attenuation of propagating field in one direction for which a technique as described below may be equally suitable. Nevertheless, a single loop is desired in most applications due to its simplicity.

To reduce the diameter of the shield, a material with higher permeability than that of air may be used between the loop and the shield to provide a lower reluctance path. To calculate a required amount of magnetic material to be placed between the loop and the shield, a value of reluctance may be provided that would result in the value of the loop's initial inductance in the absence of the shield. A material such as ferrite is desirable due to its low conductivity, which prevents (or at least keeps to a minimum) surface currents on the magnetic material which may act in the same way as currents on the inside of the shield. For the case of conducting material, it may be laminated in planes perpendicular to a line around the perimeter and may require more material (increase the inductance to a value greater than the loop) to counteract inductance reducing effect of the surface currents.

Large toroids or flat disks with holes in the centre are not commonly available so practically, the magnetic material may be in the form of rods or slabs placed in a picket fence or polygon fashion respectively. For the latter structures, a demagnetising factor associated with the material may be estimated by the following formulas.

For a rod of diameter d and length L,
N_{d}=(1−w²)/w²*(1/(2w)*In((1+w)/(1−w))−1), where w=√(1−(d/L)²).

The effective permeability is then calculated by
μ_{eff}=μᵣ/(1+(μᵣ−1)N_{d}).

The reluctance of a magnetic pathway is [symbol] =I/(μS) where I is the centreline length and S is the area of cross section. For the case of using rods, reluctance of a single rod may be calculated and the reluctance of each rod is one of n in parallel in the magnetic circuit, so
Lₗₒₒₚ=N²/( [symbol] _{rod}/n)
is used to find the number of rods required.

This method may get close to a final requirement of magnetic material, but the volume of magnetic material may require adjustment for the following reasons. Firstly the formula for reluctance assumes uniform magnetic field at the air magnetic material interface, which is approximately true for narrow rods or slabs. Secondly, the rods need to be long enough to maintain enough radius of curvature of the flux lines at the centre of the loop in order for a randomly oriented tag to dwell long enough to couple to the field while it passes through the loop. This second case relates to two inductors having the same value of inductance, but with differing distributions of field within their turns. Using a thin wall cylinder as the loop (a loop with some height) may assist in keeping the radius of curvature of the field at the centre from becoming too small for good tag coupling when a single turn loop is used.

To complete the shielding, a shield length>D1+loop height may be required to allow enough flux return area for a cylinder with closed ends. In order to pass objects through the loop, the ends may be required to be opened, thus relaxing this requirement, but in order to prevent too much field escaping the cylinder ends, the tube's length preferably is made such that it acts as a waveguide beyond cut-off, which may apply an attenuation to the wave present at the operating frequency. For a magnetic loop case, the arrangement may launch a TE₂₂ wave mode, although a conservative approach may be to make the shield long enough to give a required attenuation for the dominant mode. The attenuation required comes from the amount that the unshielded loop was over the EMC limit. The length, I, with the source at the centre of the waveguide, is related to attenuation by the formula:
[attenuation dB]=20*log10*exp(−jβ*I/2)
where β will be complex when operating below the cut-off frequency.

Finally, it is to be understood that various alterations, modifications and/or additions may be introduced into the constructions and arrangements of parts previously described without departing from the spirit or ambit of the invention.

1. A system for at least minimizing coupling nulls between an electromagnetic field derived from one or more sources and a plurality of randomly oriented RFID tags, wherein said one or more of tags is arranged to move relative to said field such that no tag is persistently located in a coupling null relative to said field.

2. A system according to claim 1 wherein the or each tag is translated and/or rotated relative to said electromagnetic field.

3. A system according to claim 1 wherein said electromagnetic field is translated and/or rotated relative to said tags.

4. A system for at least minimizing coupling nulls between an electromagnetic field derived from one or more sources and a plurality of randomly oriented RFID tags wherein the or each source includes a main axis that is oriented obliquely relative to a direction of movement of said plurality of tags.

5. A system according to claim 4 wherein the or each source of the electromagnetic field includes one or more antennas or loops and/or portals and the plurality of tags move relative to a region associated with the or each source.

6. A system according to claim 5 wherein the or each antenna, loop or portal includes an aperture through which the plurality of tags may pass.

7. A system according to claim 6 wherein tag bearing objects are dropped through said aperture followed by rotation of said objects.

8. A system according to claim 7 wherein each object is rotated between 90 to 360 degrees relative to an initial orientation of said object.

9. A system according to claim 4 wherein said main axis is oriented at an acute angle relative to said direction of movement.

10. A system according to claim 9 wherein said main axis is oriented substantially at 45 degrees relative to said direction of movement.

11. A system according to claim 5 wherein the or each antenna, loop and/or portal is rotated relative to said plurality of tags such that no tag is persistently located in a coupling null relative to said field.

12. A system according to claim 5 wherein the or each tag is rotated relative to the or each antenna, loop or portal during movement of said tags in said direction, such that no tag is persistently located in a coupling null relative to said field.

13. A method for at least minimizing coupling nulls between an electromagnetic field derived from one or more sources and a plurality of randomly oriented RFID tags, said method including moving the or each RFID tag relative to said field such that the or each RFID tag is not persistently located in a coupling null relative to said field.

14. A method according to claim 13 including translating and/or rotating the or each tag relative to said electromagnetic field.

15. A method according to claim 13 including translating and/or rotating said electromagnetic field relative to the or each tag.

16. A method for at least minimizing coupling nulls between an electromagnetic field derived from one or more sources and a plurality of randomly oriented RFID tags including orienting a main axis of the or each source obliquely relative to a direction of movement of said plurality of RFID tags.

17. A method according to claim 16 wherein the or each source of the electromagnetic field includes one or more antennas or loops and/or portals and the plurality of tags moves relative to a region associated with the or each source.

18. A method according to claim 17 wherein the or each antenna, loop or portal includes an aperture through which the plurality of tags may pass.

19. A method according to claim 18 including dropping tag bearing objects through said aperture followed by rotation of said objects.

20. A method according to claim 19 wherein each object is rotated between 90 to 360 degrees relative to an initial orientation of said object.

21. A method according to claim 16 wherein said main axis is oriented at an acute angle relative to said direction of movement.

22. A method according to claim 21 wherein said main axis is oriented substantially at 45 degrees relative to said direction of movement.

23. A method according to claim 17 including rotating the or each antenna, loop and/or portal relative to said plurality of tags such that no tag is persistently located in a coupling null relative to said field.

24. A method according to claim 17 including rotating the or each tag relative to the or each antenna, loop or portal during movement of said tags in said direction, such that no tag is persistently located in a coupling null relative to said field.

25. (canceled)

26. (canceled)
